(19) United States
(12) Patent Application Publication
(10) Pub. No.: US 2004/0145613 A1
(43) Pub. Date: Jul. 29, 2004

(54) User Interface using acceleration for input

(76) Inventors: Donald J. Stavely, Windsor, CO (US); Wilfred Francis Brake, Fort Collins, CO (US); Dan L. Dalton, Greeley, CO (US); James C. Dow, Fort Collins, CO (US); Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/354,545

(22) Filed: Jan. 29, 2003

(51) Int. Cl. G09G 5/00; G06K 11/06; G08C 21/00; G09B 25/00

(52) U.S. Cl. 345/863; 345/831; 345/864; 345/156; 178/18.01; 434/393

(57) ABSTRACT

In a preferred embodiment, accelerometers are used as the input devices for an appliance user interface. A first accelerometer is positioned with an orientation substantially different from the orientation of a second accelerometer. The users may either tilt, tap, or tilt and tap on an appliance to invoke different operations of the appliance.

### FIELD OF THE INVENTION

This invention relates generally to electronic devices and more specifically to using acceleration for input to portable appliances.

### BACKGROUND OF THE INVENTION

Portable devices such as cell phones, digital cameras, game devices, and Personal Digital Assistants (PDA's) need some form of user input device(s) for controlling their functions. This is especially true as these appliances have more sophisticated functions, and more capable graphic displays.

Touch screens have become the standard user interface for PDA'S. They are very powerful and intuitive, since they are true pointing devices. On the other hand, touch screens use plastic films that are fragile. They are easily scratched, gouged, or torn, especially by the tip of a stylus.

Cell phones, digital cameras, and games currently use a number of buttons for input. For example, “arrow keys” are used to move left, right, up, and down through menus and to scroll through content on the display. Yet other buttons are needed for confirming or canceling a selection. In many ways, using buttons to navigate a complex graphical user interface has proven clumsy and unnatural. Also, as portable appliances get smaller and more capable, it is difficult to find room for the large number of buttons needed.

There is a need in the art for alternatives to navigation buttons that are more compact and more intuitive.

### SUMMARY OF THE INVENTION

In a preferred embodiment, accelerometers are used as the input devices for an appliance user interface. A first accelerometer is positioned with an orientation substantially different from the orientation of a second accelerometer. The users may either tilt, tap, or tilt and tap on an appliance to invoke different operations of the appliance.

Other aspects and advantages of the present invention will become apparent from the following detailed description, taken in conjunction with the accompanying drawings illustrating by way of example the principles of the invention.

### BRIEF DESCRIPTION OF THE DRAWINGS

FIG. 1 is a diagram of a digital camera with arrow and ok buttons.

Prior Art

FIG. 2 is a diagram of a digital camera where accelerometers are used to provide input.

### DETAILED DESCRIPTION OF THE PREFERRED EMBODIMENT

This invention uses one or more acceleration sensors to detect the movement of an appliance. Acceleration of sensors may be accomplished by using gravity as a reference, by tilting an appliance, or by tapping an appliance. By using two accelerometers, where one of the accelerometers is positioned with an orientation substantially different from the orientation of the other accelerometer, acceleration is sensed to measure tilt side-to-side (roll) and front-to-back (pitch). These motions are used as an alternative to pressing arrow keys to navigate a user interface in two directions. For example, tilting the camera to one side could scroll information in that direction. Tilting forward or backward could invoke other functions, such as presenting and scrolling up and down a menu.

Measuring the direction of tilt is an analog function, thus it can be used for proportional control. For example, tilting further could scroll information further or faster. By contrast, arrow buttons must be pressed repetitively. The resulting affect to the user is very natural and intuitive—like “pouring” the display from one side to the other.

Another embodiment of the invention uses the accelerometers to detect when the user taps on the appliance. Tapping is distinguished from tilting by its transient nature. Tilting generates a low frequency and DC signal, while tapping generates a higher frequency signal. Again by using two accelerometers, where one accelerometer is oriented substantially differently from the other accelerometer, the direction of the tap can be identified. Tapping the top left of the appliance gives a signal in one direction of the roll sensor, and tapping the top right gives a signal in the opposite direction. Similarly, taps on the top back and bottom back of the appliance give positive and negative pitch signals.

The two actions of tilting and tapping can be used together in an integrated user interface. For example, in a digital camera, tilting the camera scrolls among a number of stored images or menu items, as described above. Then tapping the camera case indicates a selection or confirmation. This replicates the functions of a conventional camera user interface with four arrow buttons and an “OK” button.

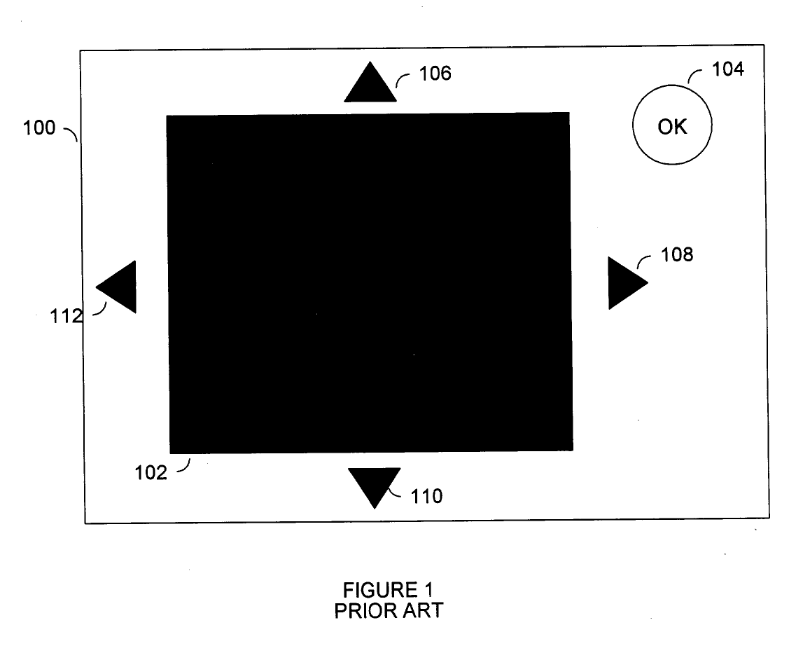

FIG. 1 is a drawing illustrating the arrow functions, 106, 108, 110, and 112, and the “OK” function, 104, on a digital camera, 100. The arrow functions, 106, 108, 110, and 112, are located above and below and on the sides of the camera screen, 102. The OK function, 104, is located in the upper right corner of the camera, 100.

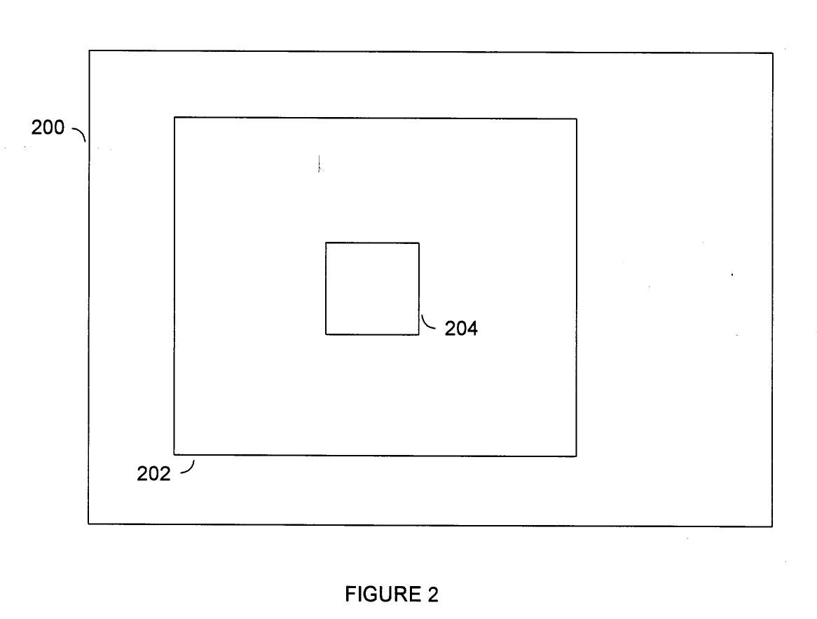

FIG. 2 is a drawing of a digital camera, 200, that includes an accelerometer module, 204, below the camera screen, 202. The accelerometer module, 204, includes two accelerometers, one orthogonal to the other. Tilting the camera shown in FIG. 2 to the right or left replaces the arrow functions, 112 and 108, in FIG. 1. Tilting the camera shown in FIG. 2 up or down replaces the arrow functions, 106 and 110, in FIG. 1. Tapping the camera shown in FIG. 2 replaces the OK function, 104, in FIG. 1.

Acceleration sensors are available that are well suited to this application. For example, National Semiconductor makes a component with two orthogonal micromachined silicon accelerometers in a single package. This part is small, inexpensive, low power, and easily interfaced to common microprocessors.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) An appliance comprising:
a) an accelerometer;
b) wherein movement of the accelerometer provides input to an appliance user interface.

2) The appliance of claim 1 wherein movement of the accelerometer is accomplished by tilting the appliance.

3) The appliance of claim 1 wherein movement of the accelerometer is accomplished by tapping the appliance.

4) The appliance of claim 1 wherein movement of the accelerometer is accomplished by tilting and tapping the appliance.

5) The appliance of claim 1 wherein movement of the accelerometer is accomplished using gravity.

6) The appliance of claim 1 wherein the appliance is a cell phone.

7) The appliance of claim 1 wherein the appliance is a digital camera.

8) The appliance of claim 1 wherein the appliance is a game device.

9) The appliance of claim 1 wherein the appliance is a PDA.

10) An appliance comprising:
a) a first accelerometer;
b) a second accelerometer, the second accelerometer positioned with an orientation substantially different from the orientation of the first accelerometer;
c) wherein movement of the accelerometers provides input to an appliance user interface.

11) The appliance of claim 10 wherein movement of the accelerometers is accomplished by tilting the appliance.

12) The appliance of claim 10 wherein movement of the accelerometers is accomplished by tapping the appliance.

13) The appliance of claim 10 wherein movement of the accelerometers is accomplished by tilting and tapping the appliance.

14) The appliance of claim 10 wherein movement of the accelerometers is accomplished using gravity.

15) The appliance of claim 10 wherein the appliance is a cell phone.

16) The appliance of claim 10 wherein the appliance is a digital camera.

17) The appliance of claim 10 wherein the appliance is a game device.

18) The appliance of claim 10 wherein the appliance is a PDA.

19) A method for providing input to an appliance user interface comprising:
a) installing a accelerometer on the appliance;
b) moving the appliance to provide input to the appliance user interface.

20) The method of claim 19 wherein the moving of the appliance is accomplished by tilting the appliance.

21) The method of claim 19 wherein the moving of the appliance is accomplished by tapping the appliance.

22) The method of claim 19 wherein the moving of the appliance is accomplished by tilting and tilting the appliance.

23) A method for providing input to an appliance user interface comprising:
a) installing a first accelerometer on the appliance;
b) installing a second accelerometer, the second accelerometer positioned with an orientation substantially different from the orientation of the first accelerometer;
c) moving the appliance to provide input to the appliance user interface.

24) The method of claim 23 wherein the moving of the appliance is accomplished by tilting the appliance.

25) The method of claim 23 wherein the moving of the appliance is accomplished by tapping the appliance.

26) The method of claim 23 wherein the moving of the appliance is accomplished by tilting and tilting the appliance.

27) An appliance comprising:
a) a first means for detecting acceleration;
b) a second means for detecting acceleration, the second means for detecting acceleration positioned with an orientation substantially different from the orientation of the first means for detecting acceleration;
c) wherein movement of the means for acceleration provide input to an appliance user interface.
